(19) United States
(12) Patent Application Publication
(10) Pub. No.: US 2025/0353031 A1
(43) Pub. Date: Nov. 20, 2025

(54) ENABLING ROLL-TO-ROLL MANUFACTURE OF GRADIENT THIN FILM WITH MULTIFUNCTIONAL PROPERTIES

(71) Applicant: Georgia Tech Research Corporation, Atlanta, GA (US)

(72) Inventors: Tae Joong Jeong, Atlanta, GA (US); Tequila A. L. Harris, Atlanta, GA (US)

(21) Appl. No.: 18/872,203

(22) PCT Filed: Jun. 7, 2023
(86) PCT No.: PCT/US2023/068034

§ 371 Date: Dec. 5, 2024

Related U.S. Application Data
(60) Provisional application No. 63/366,037, filed on Jun. 8, 2022.

(51) Int. Cl. B05C 5/02; B05D 1/26

(52) U.S. Cl. CPC B05C 5/0258; B05C 5/0245; B05D 1/265

(57) ABSTRACT

A scaling and patterning apparatus for producing thin films with multi-material, customized gradient patterns is disclosed. The apparatus includes a slot die body integrated with multiple inlets and corresponding converging channels passing materials through the die body into a geometry configured for mixing the materials internally. The scaling and patterning apparatus may be used in a method of preparing multi-material, gradient patterned thin film materials.

### CROSS-REFERENCE TO RELATED APPLICATIONS

This application claims priority under 35 U.S.C. § 119 (c) to U.S. Provisional Patent Application No. 63/366,037 filed 8 Jun. 2022, the entire contents and substance of which is hereby incorporated by reference as if fully set forth below.

### FIELD OF THE DISCLOSURE

The various embodiments of this disclosure relate generally to coating thin films and, more particularly, to an apparatus and method for producing scaled and patterned thin films.

### BACKGROUND

Recently, gradient thin films have received more interest due to their versatility in a plethora of research fields such as, but not limited to, packaging of flexible electronics, controlled cell growth in lab-on-a-chip (biosensors), thin film electrical devices and production of nanopaper. Gradient structures are advantageous because they have been shown to improve the functionality of materials such as the electrical, thermal, adhesive and mechanical properties. The enhancements of these properties can be realized by fabricating the gradient thin film such that the gradient interface is formed through the thickness or along the sidewalls of each coated material. These structures can be composed of two or more different materials or by using different concentrations of the same material. There are many processes for creating thin films, and these methods were developed to meet the manufacturing needs of specific technologies. For example, existing solution coating technologies such as slot die, curtain, and knife coating are able to manufacture thin films. These techniques were designed for creating high quality films in continuous single sheets. These techniques, however, have a limited ability and challenges in terms of scalability, material selection, and waste production.

Amongst the well-known coating methods, slot die coating is a method of creating thin films on a substrate from liquid materials. The essence of the process is a die consisting of two halves separated by a shim, with a pressurized reservoir, or chamber, machined into one of the halves containing fluid. The purpose of the shim is to create a gap between the two halves through which the fluid may flow. The purpose of the chamber is to mix the fluid therein along the width of the gap. As a result, slot die designs are generally limited to lines or stripes that are the opening of the shim, thereby limiting the ability of the slot die to create other desired patterns.

Gradient patterns have been developed using both active and passive mixing mechanisms. For active mixing, an external force is applied to allow mixing to occur which includes sources like acoustic, thermal and magnetic actuators. Even though active methods have been successful in inducing microfluidic mixing, they are very complex. Passive mixing in microfluidics occurs as multiple fluids simultaneously pass through a micro sized flow cavity. Therefore, channel design has the highest impact on mixing as well as certain parameters like flow rate and viscosity. Cavity shapes like T-Junction, Y-junction and flow splitter have been successfully used channel design. However, the junctional geometries have worked best at very low flow rates (50˜500 nL/min), which is not favorable for scaled manufacturing. Like the active mixing techniques, the flow splitter geometries are complex. Thus, new geometries that allow for significantly higher flow rates while mixing are needed.

Studies of slot die coating have investigated flow channel geometry that allows for mixing to occur in a planar geometry for a wide range of fluid properties and flow parameters for microfluidic devices. Mixing was induced by controlling the flow dynamics of two fluids flowing through a planar geometry with periodic microchannels, based on the relationships between Peclet number, viscosities and flow rates ratio of the two fluidic materials. While conventional studies demonstrated that fluid gradients can be formed, the work was limited to the internal geometry of a closed microfluidic device. Therefore, it is not understood whether such structural gradients can be maintained beyond the constrained and confined geometry of the microchannels to allow for graded coatings.

Replicating the advantages of traditional slot coating to scale the production of functionally graded thin film structures is an appealing prospect.

### BRIEF SUMMARY OF THE INVENTION

Some exemplary embodiments of this disclosure provide an apparatus and a system for scaling and patterning thin film materials. Other exemplary embodiments provide methods of producing scaled and patterned thin film materials.

To realize a system capable of producing scalable gradient patterned films, there is provided a hybrid scaling patterning system. This system allows for single-step deposition of multi-material patterned thin films, originating from multiple separate fluids being mixed, and thus, improved gradient patterned thin film processing for technologies that require gradient film patterns or the enhanced properties thereof.

According to an exemplary embodiments, an apparatus for patterning thin films provides a plurality of fluid inlets, a plurality of mixing chambers configured to receive at least two fluids from the plurality of fluid inlets and mix the at least two fluids to create a fluid mixture, and a slot die outlet configured to receive the fluid mixture and deposit the fluid mixture onto a substrate, wherein the plurality of mixing chambers are arranged serially in a flow direction from the plurality of fluid inlets to the slot die outlet.

In any of exemplary embodiments disclosed herein, the plurality of mixing chambers provides a first mixing chamber including a fluid inlet, a fluid outlet, and a cavity between the fluid inlet and the fluid outlet, wherein the cavity of the first mixing chamber has a variable cross-sectional area normal to a direction of flow through the first mixing chamber. In various exemplary embodiments of the disclosure the cavity has different shapes, including ovular, hexagonal, etc.

In any of exemplary embodiments disclosed herein, the cavity has a generally ovular shape.

In any of exemplary embodiments disclosed herein, the cavity has a generally hexagonal shape.

In any of exemplary embodiments disclosed herein, the cavity includes an upper portion having first and second ends, the first end proximate the fluid inlet of the first mixing chamber, a central potion having first and second ends, the first end proximate the second end of the upper portion of the first mixing chamber, and a lower portion having first and second ends, the first end proximate the second end of the central portion, the second end proximate the fluid outlet of the first mixing chamber.

In any of exemplary embodiments disclosed herein, the upper portion includes a cross-sectional area normal to the direction of flow that increases from the first end of the upper portion to the second end of the upper portion.

In any of exemplary embodiments disclosed herein, the upper portion includes a cross-sectional area normal to the direction of flow that increases linearly from the first end of the upper portion to the second end of the upper portion.

In any of exemplary embodiments disclosed herein, the upper portion includes a cross-sectional area normal to the direction of flow that increases non-linearly from the first end of the upper portion to the second end of the upper portion.

In any of exemplary embodiments disclosed herein, the lower portion includes a cross-sectional area normal to the direction of flow that decreases from the first end of the lower portion to the second end of the lower portion.

In any of exemplary embodiments disclosed herein, the lower portion includes a cross-sectional area normal to the direction of flow that decreases linearly from the first end of the lower portion to the second end of the lower portion.

In any of exemplary embodiments disclosed herein, the lower portion includes a cross-sectional area normal to the direction of flow that decreases non-linearly from the first end of the lower portion to the second end of the lower portion.

In any of exemplary embodiments disclosed herein, the central portion includes a cross-sectional area normal to the direction of flow that is constant from the first end of the central portion to the second end of the central portion.

In any of exemplary embodiments disclosed herein, the fluid inlet of the first mixing chamber provides a first end and a second end, the second end proximate the first end of the upper portion of the first mixing chamber, wherein the fluid inlet of the first mixing chamber has a cross-sectional area normal to the direction of flow that increases from the first end of the fluid inlet to the second end of the fluid inlet.

In any of exemplary embodiments disclosed herein, the fluid inlet of the first mixing chamber has a cross-sectional area normal to the direction of flow that increases non-linearly from the first end of the fluid inlet to the second end of the fluid inlet.

In any of exemplary embodiments disclosed herein, the fluid outlet of the first mixing chamber provides a first end and a second end, the first end proximate the second end of the lower portion of the first mixing chamber, wherein the fluid outlet of the first mixing chamber has a cross-sectional area normal to the direction of flow that decreases from the first end of the fluid outlet to the second end of the fluid outlet.

In any of exemplary embodiments disclosed herein, the fluid outlet of the first mixing chamber has a cross-sectional area normal to the direction of flow that decreases non-linearly from the first end of the fluid outlet to the second end of the fluid outlet.

In any of exemplary embodiments disclosed herein, the plurality of fluid inlets provides a first fluid inlet and a second fluid inlet.

In any of exemplary embodiments disclosed herein, the plurality of fluid inlets further provides a third fluid inlet.

In any of exemplary embodiments disclosed herein, the at least two fluids provide a first fluid and a second fluid, the first fluid inlet configured to feed the first fluid to the plurality of mixing chambers and the second fluid inlet configured to feed the second fluid to the plurality of mixing chambers.

In any of exemplary embodiments disclosed herein, the at least two fluids provide a first fluid and a second fluid, the first fluid inlet configured to feed the first fluid to the plurality of mixing chambers and the second and third fluid inlets configured to feed the second fluid to the plurality of mixing chambers.

In any of exemplary embodiments disclosed herein, the at least two fluids provide a first fluid, a second fluid, and a third fluid, the first fluid inlet configured to feed the first fluid to the plurality of mixing chambers and the second fluid inlet configured to feed the second fluid to the plurality of mixing chambers.

In any of exemplary embodiments disclosed herein, the plurality of mixing chambers provides an entry chamber including a fluid inlet, a fluid outlet, and a cavity between the fluid inlet and the fluid outlet, wherein the cavity of the entry chamber has a variable cross-sectional area normal to a direction of flow through the first mixing chamber.

In any of exemplary embodiments disclosed herein, the entry chamber cavity has a generally semi-circular shape.

In any of exemplary embodiments disclosed herein, the entry chamber cavity has a generally pentagonal shape.

In any of exemplary embodiments disclosed herein, the entry chamber cavity includes an upper portion having first and second ends, the first end proximate the fluid inlet of the entry chamber and a lower portion having first and second ends, the first end proximate the second end of the upper portion, the second end proximate the fluid outlet of the entry chamber.

In any of exemplary embodiments disclosed herein, the lower portion of the entry chamber cavity has a cross-sectional area normal to the direction of flow that decreases from the first end of the lower portion to the second end of the lower portion.

In any of exemplary embodiments disclosed herein, the lower portion of the entry chamber cavity has a cross-sectional area normal to the direction of flow that decreases linearly from the first end of the lower portion to the second end of the lower portion.

In any of exemplary embodiments disclosed herein, the lower portion of the entry chamber cavity has a cross-sectional area normal to the direction of flow that decreases non-linearly from the first end of the lower portion to the second end of the lower portion.

In any of exemplary embodiments disclosed herein, the upper portion of the entry chamber cavity has a cross-sectional area normal to the direction of flow that is constant from the first end of the upper portion to the second end of the central portion.

In any of exemplary embodiments disclosed herein, the fluid inlet of the entry chamber is proximate the plurality of fluid inlets of the apparatus.

In any of exemplary embodiments disclosed herein, the fluid outlet of the entry chamber comprises a first end and a second end, the first end proximate the second end of the lower portion of the entry chamber, wherein the fluid outlet of the entry chamber has a cross-sectional area normal to the direction of flow that decreases from the first end of the fluid outlet to the second end of the fluid outlet.

In any of exemplary embodiments disclosed herein, the fluid outlet of the entry chamber has a cross-sectional area normal to the direction of flow that decreases non-linearly from the first end of the fluid outlet to the second end of the fluid outlet.

In any of exemplary embodiments disclosed herein, the plurality of mixing chambers provides an exit chamber, including a fluid inlet, a fluid outlet, and a cavity between the fluid inlet and the fluid outlet, wherein the cavity of the entry chamber has a variable cross-sectional area normal to a direction of flow through the first mixing chamber. Across various exemplary embodiments disclosed herein, the cavity varies in shape including shapes such as pentagonal, semi-circular, etc.

In any of exemplary embodiments disclosed herein, the exit chamber cavity has a generally semi-circular shape.

In any of exemplary embodiments disclosed herein, the exit chamber cavity has a generally pentagonal shape.

In any of exemplary embodiments disclosed herein, the exit chamber cavity includes an upper portion having first and second ends, the first end proximate the fluid inlet of the exit chamber and a lower portion having first and second ends, the first end proximate the second end of the upper portion, the second end proximate the fluid outlet of the exit chamber.

In any of exemplary embodiments disclosed herein, the upper portion of the exit chamber cavity has a cross-sectional area normal to the direction of flow that increases from the first end of the upper portion to the second end of the upper portion.

In any of exemplary embodiments disclosed herein, the upper portion of the exit chamber cavity has a cross-sectional area normal to the direction of flow that increases linearly from the first end of the upper portion to the second end of the upper portion.

In any of exemplary embodiments disclosed herein, the upper portion of the exit chamber cavity has a cross-sectional area normal to the direction of flow that increases non-linearly from the first end of the upper portion to the second end of the upper portion.

In any of exemplary embodiments disclosed herein, the lower portion of the exit chamber cavity has a cross-sectional area normal to the direction of flow that is constant from the first end of the lower portion to the second end of the lower portion.

In any of exemplary embodiments disclosed herein, the fluid outlet of the exit chamber is proximate the slot die outlet of the apparatus.

In any of exemplary embodiments disclosed herein, the fluid inlet of the exit chamber comprises a first end and a second end, the second end proximate the first end of the upper portion of the exit chamber, wherein the fluid inlet of the exit chamber has a cross-sectional area normal to the direction of flow that increases from the first end of the fluid inlet to the second end of the fluid inlet.

In any of exemplary embodiments disclosed herein, the fluid inlet of the exit chamber has a cross-sectional area normal to the direction of flow that increases non-linearly from the first end of the fluid inlet to the second end of the fluid inlet.

In any of exemplary embodiments disclosed herein, the plurality of fluid inlets, the plurality of mixing chambers, and the slot die outlet are configured to enable fluidic communication through the apparatus in a continuous flow.

In any of exemplary embodiments disclosed herein, the apparatus further includes one or more additional plurality of mixing chambers configured to receive at least two fluids from the plurality of fluid inlets and mix the at least two fluids to create a fluid mixture.

In any of exemplary embodiments disclosed herein, the plurality of mixing chambers further provides characteristics optimizable based on the at least two fluids.

In any of exemplary embodiments disclosed herein, the plurality of mixing chambers is configured to enable a turbulent flow of the at least two fluids through the apparatus.

In any of exemplary embodiments disclosed herein, the apparatus includes a material selected from the group consisting of stainless steel, aluminum, nylon, polycarbonate and combinations thereof.

In any of exemplary embodiments disclosed herein, the apparatus is configured to generate a scaled gradient pattern from mixing the at least two fluids within plurality of mixing chambers.

According to another exemplary embodiment, a method of thin film material deposition on a substrate provides feeding at least two fluids into a slot die via a plurality of fluid inlets, forming a fluid multi-material by interacting the at least two fluids in a plurality of mixing chambers within the slot die, the plurality of mixing chambers in fluidic communication with the plurality of fluid inlets such that the at least two fluids mix within the plurality of mixing chambers, and depositing the fluid multi-material onto the substrate via an outlet of the slot die in fluidic communication with the plurality of mixing chambers. In some embodiments the deposited multi-material film can contain primarily the first fluid material on one side of the gradient area and primarily the second fluid material on the other side of the gradient area.

In any of exemplary embodiments disclosed herein, the method can further provide feeding the at least two fluids at a plurality of fluid flow rates.

In any of exemplary embodiments disclosed herein, the method can further provide the at least two fluids comprise a first fluid and a second fluid, feeding the first fluid into the slot die at a first fluid rate and feeding the second fluid into the slot die at a second fluid rate.

In any of exemplary embodiments disclosed herein, the method can further provide the plurality of fluid inlets including a first fluid inlet and a second fluid inlet, the first fluid being fed into the first fluid inlet and the second fluid being fed into the second fluid inlet.

In any of exemplary embodiments disclosed herein, the method can further provide the plurality of fluid inlets including a first fluid inlet, a second fluid inlet, and a third fluid inlet, the first fluid being fed into the first fluid inlet and the second fluid being fed into the second fluid inlet and the third fluid inlet.

In any of exemplary embodiments disclosed herein, the method can further provide controlling the plurality of fluid flow rates to adjust a mixture ratio of the at least two fluids.

In any of exemplary embodiments disclosed herein, the method can further provide dimensionally scaling at least a portion of the fluid multi-material.

In any of exemplary embodiments disclosed herein, the method can further provide the slot die including a first plate, a second plate, a shim separating the first plate and the second plate.

In any of exemplary embodiments disclosed herein, the method can further provide controlling dimensions of the plurality of mixing chambers adjusts a mixture ratio of the at least two fluids.

In any of exemplary embodiments of the present invention, each respective set of the fluid inlets can be both positioned at a fluid inlet height position between a top and bottom of the slot die, the distance between the top and bottom of the slot die defining a height of the slot die and positioned at a fluid inlet width position between a first side and a second side of the slot die, the distance between the sides of the slot die defining a width of the slot die.

In any of exemplary embodiments of the present invention, each fluid inlet height position of a respective set of the fluid inlets can be the same.

In any of exemplary embodiments of the present invention, each fluid inlet width position of a respective set of the fluid inlets can be different.

In any of exemplary embodiments of the present invention, each respective set of the fluid inlets can present a horizontal line of spaced-apart fluid inlets.

In any of exemplary embodiments of the present invention, each horizontal line of spaced-apart fluid inlets can be at a different fluid inlet height position one from another.

In any of exemplary embodiments of the present invention, the slot die used in the method need not include a shim.

Other aspects and features of exemplary embodiments of this disclosure will become apparent to those of ordinary skill in the art, upon reviewing the following description of specific, exemplary embodiments of this disclosure in concert with the various figures. While features of this disclosure may be discussed relative to certain exemplary embodiments and figures, all exemplary embodiments of this disclosure can include one or more of the features discussed in this application. While one or more exemplary embodiments may be discussed as having certain advantageous features, one or more of such features may also be used with the other various exemplary embodiments discussed in this application. In similar fashion, while exemplary embodiments may be discussed below as system or method exemplary embodiments, it is to be understood that such exemplary embodiments can be implemented in various devices, systems, and methods. As such, discussion of one feature with one exemplary embodiment does not limit other exemplary embodiments from possessing and including that same feature.

### BRIEF DESCRIPTION OF THE DRAWINGS

The accompanying Figures, which are incorporated in and constitute a part of this specification, illustrate several aspects described below.

FIG. 1A illustrates a schematic of a coating tool coating in a R2R environment, in accordance with some exemplary embodiments of the disclosure.

FIG. 1B illustrates components of a coating tool, in accordance with some exemplary embodiments of this disclosure.

FIGS. 2A-2E illustrate components of a coating tool and the internal geometry of a coating tool, in accordance with some exemplary embodiments of this disclosure.

FIG. 3 illustrates a chart of test results depicting coatings deposited from a coating tool at different ranges of flow rates both at the lower and upper Pe limit, in accordance with some exemplary embodiments of this disclosure.

FIGS. 4A-4B illustrate test results related to the effect of change in flow rate to the dimension of the gradient film, in accordance with some exemplary embodiments of this disclosure.

FIG. 5 illustrates a chart of test results depicting coatings deposited from a coating tool at different ranges of flow rates both at the lower and upper Pe limit, in accordance with some exemplary embodiments of this disclosure.

FIGS. 6A and 6B illustrate functionally graded thin films deposited form a coating tool, in accordance with some exemplary embodiments of this disclosure. FIG. 6A illustrates an exemplary embodiment with PEDOT:PSS as the center fluid and 7.5 wt. % PVA as the side fluids. FIG. 6B illustrates an exemplary embodiment with 25 wt. % PEI as the center fluid and 10 wt. % PVA as the side fluids.

FIGS. 7A-7D illustrate injected fluids flowing through components of a coating tool and the internal geometry of a coating tool, in accordance with some exemplary embodiments of this disclosure. FIG. 7A illustrates the flow of 20 wt. % PVA and 10 wt. % PVA, FIG. 7B illustrates the flow of 15 wt. % PVA and 10 wt. % PVA, FIG. 7C illustrates the flow of PEDOT:PSS and 7.5 wt. % PVA, and FIG. 7D illustrates the flow of 25 wt. % PEI and 10 wt. % PVA, all in accordance with some exemplary embodiments of this disclosure.

FIGS. 8A-8C illustrate cross sectional images of PVA/PVA gradient film with FIG. 8A illustrating the center area, FIG. 8B illustrating the side area and FIG. 8C illustrating the gradient area, in accordance with some exemplary embodiments of this disclosure.

FIG. 9 illustrates test results from regions of a multi-material coatings deposited from a coating tool, in accordance with some exemplary embodiments of this disclosure.

FIGS. 10A-E illustrate test results from adhesion testing of various thin films, in accordance with some exemplary embodiments of the disclosure. FIG. 10A illustrates an original, a cross-cut, and an adhesion tested of a 10 wt. % PVA thin film, FIG. 10B illustrates an original, a cross-cut, and an adhesion tested of a 20 wt. %/10 wt. % PVA gradient thin film, FIG. 10C illustrates an original, a cross-cut, and an adhesion tested of a PEDOT:PSS/7.5 wt. % PVA gradient thin film, FIG. 10D illustrates an original, a cross-cut, and an adhesion tested of a 25 wt. % PEI/10 wt. % PVA gradient thin film, and FIG. 10E illustrates an original, a cross-cut, and an adhesion tested of a fully blended 25 wt. % PEI/10 wt. % PVA thin film, all in accordance with some exemplary embodiments of the disclosure.

FIG. 11 illustrates test results for multi-material film electrical conductivity at different PEDOT:PSS/PVA ratios, in accordance with some exemplary embodiments of the disclosure.

FIG. 12 illustrates FTIR test results for multi-material films of different ratio of PEDOT:PSS/PVA, in accordance with some exemplary embodiments of the disclosure.

FIG. 13 illustrates FTIR test results for multi-material films, in accordance with some exemplary embodiments of the disclosure.

FIG. 14 illustrates FTIR test results for multi-material films, in accordance with some exemplary embodiments of the disclosure.

### DETAILED DESCRIPTION OF THE INVENTION

To facilitate an understanding of the principles and features of the various exemplary embodiments of the invention, various illustrative exemplary embodiments are explained below. Although exemplary embodiments of the invention are explained in detail, it is to be understood that other exemplary embodiments are contemplated. Accordingly, it is not intended that the invention is limited in its scope to the details of construction and arrangement of components set forth in the following description or illustrated in the drawings. The invention is capable of other exemplary embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

The various exemplary embodiments of this disclosure relate to a system and apparatus for the patterning of thin films. The methods of manufacturing patterned thin films using the hybrid system are also described herein.

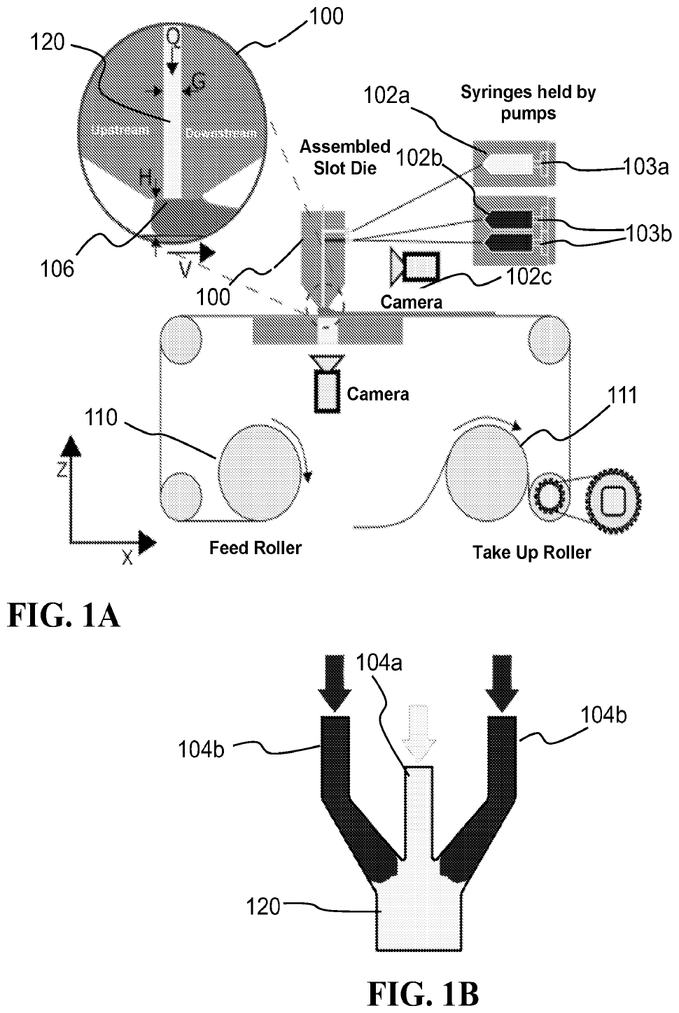

Referring now to FIG. 1A, there is shown an exemplary method of the present disclosure providing a coating tool 101 (e.g. slot die, hybrid patterning apparatus), a heterogeneous liquid film 102c comprising two or more liquid materials in a gradient-patterned configuration, two or more fluid injection pumps 103a and 103b connected to an array of two or more fluid inlets 104a and 104b, a flow of two or more inks or other coating fluid 102a and 102b into the coating tool, and a region of outflow of ink or other coating fluid 106 out of the coating tool 100 and onto a substrate to form a liquid film 102c. The coating tool 100 can further include substrate, ink or coating fluid 106 outflow from an interior channel 120 of the coating tool 100, and deposited liquid film 102c, and a die plate.

During operation, one or more liquid bridges form between the coating tool outlet and the substrate. The transfer of fluid through each liquid bridge, in turn, forms a patterned liquid film on the substrate surface. The volumetric flow rate Q, substrate velocity V relative to the coating tool, and the coating gap H between tool outlet and substrate are input parameters that can be varied during operation.

FIG. 1A further provides a schematic of an exemplary method for dual slot die coating involving the disposal a liquid film 102c upon a supporting base layer. FIG. 1B provides a magnified coating window of the same exemplary method of FIG. 1A. At the outset of the method, the two or more inks or other coating fluid 102a and 102b reside within a pair of respective fluid injection pumps 103a and 103b. The fluid injection pumps 103a and 103b inject the two or more inks or other coating fluid 102a and 102b into a dual slot die coater 100 through at least two inlet slots 104a and 104b therein. The two or more inks or other coating fluid 102a and 102b each flow through respective slots 104a and 104b such that the two or more inks or other coating fluid 102a and 102b can interact and mix within an interior channel 120 and exit the dual slot die coater 100 as a liquid film 102c in a coating window at controlled speeds and angles onto the supporting base layer. The supporting base layer can slide perpendicular to the dual slot die coater 100 such that the liquid film 102c exiting the slot die coater 100 may spread across the supporting base layer. The supporting base layer sits on a conveyer, moving due to the unraveling of the conveyer from around a feed roller 110 and an onto a motorized take-up roller 111 at the opposite end of the feed roller 110.

The coating tool body can be made of any machinable material typically used in making a coating tool such as a slot die. These include but are not limited to stainless steel, aluminum, titanium, nylon, polycarbonate and combinations thereof. The material used to make coating tool body generally is a function of the fluid that will be deposited. There should be compatibility between the coating tool and the fluid with respect to chemical, electrical, mechanical, and physical properties

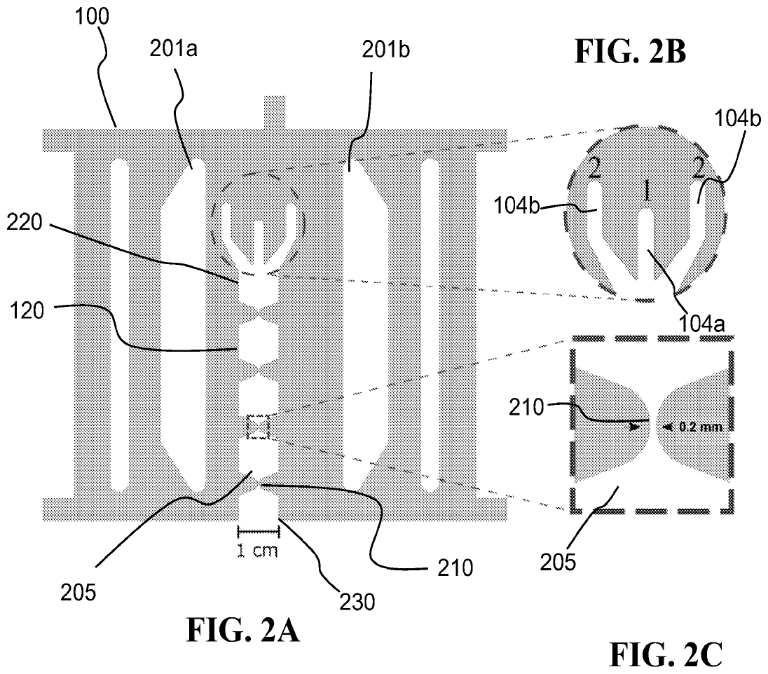

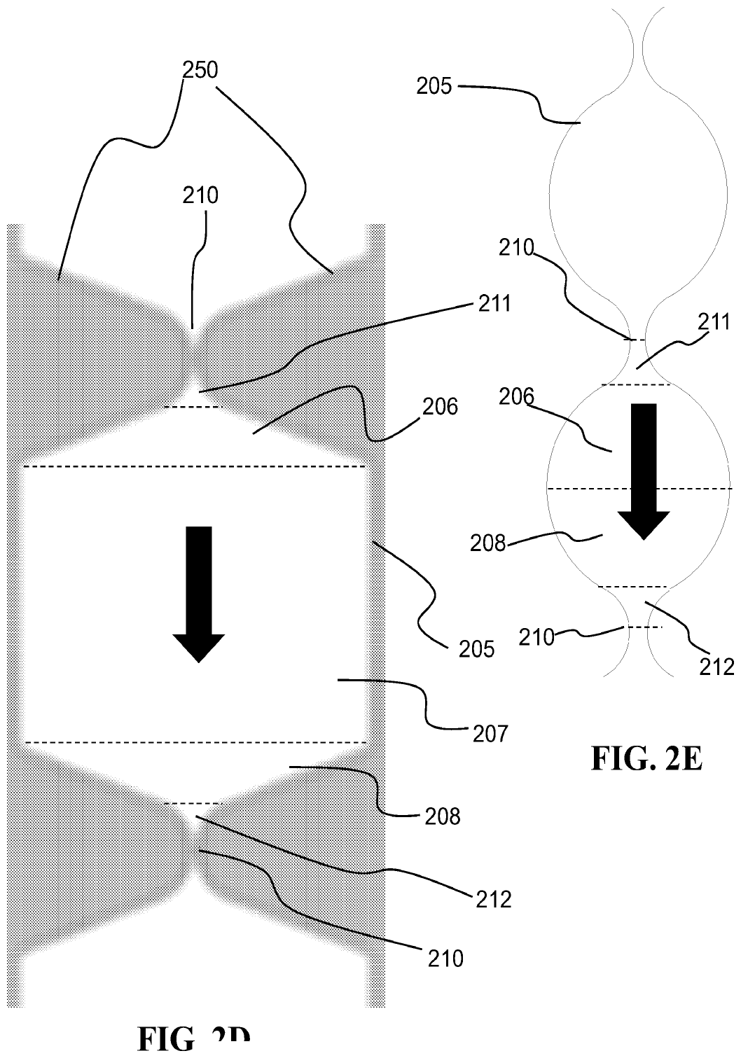

FIGS. 2A-2C show slot die components in certain exemplary embodiments of the disclosure. As shown in FIG. 2A, the coating tool 100 can include a slot die that includes a die body having two halves, or first and second plates, 201a, 201b, separated by one or more shims 250 with cutout(s) forming an interaction channel 120 positioned between first and second plates 201a, 201b for containing fluid to be deposited. It further includes an array of inlets 104a and 104b for delivering coating fluid to discrete regions of the internal geometry, which can include an entry chamber 220, a series of mixing chamber(s) 205 and microchannels 210 leading to an exit chamber 230. Coating fluid can outflow from exit chamber and out of the coating tool 100. FIG. 2B shows a magnified view of the array of inlets 104a and 104b of the coating tool 100 of an exemplary embodiment.

FIG. 2C shows a magnified view of one or more shims with cutout(s) forming an internal slot-shaped channel of internal mixing chambers 205 connected by microchannels 210, of an exemplary embodiment. The microchannels are formed by the combination of the fluid inlet 211 and a fluid outlet 212 of the corresponding entry 220, exit 230, and/or mixing chambers 205. The fluid inlet 211 can be proximate a fluid outlet 212 and proximate to an upper portion of a mixing chamber 206 or an upper portion of the exit chamber 230. The fluid outlet 212 can be proximate to a fluid inlet 211 and to a lower portion of a mixing chamber 208 or the lower portion of an entry chamber 220. A cross sectional area normal to the flow of the fluid through the microchannel can be variable. In an exemplary embodiment as shown in FIG. 2C, from an upstream portion to a downstream portion, the cross-sectional area of the fluid outlet 212, from the start of the microchannel until a midpoint of the microchannel 210, can initially decrease. The cross-sectional area, from an upstream portion to a downstream portion, of the fluid inlet 211, from the midpoint of the microchannel 210 until the end of the microchannel, can increase. In some of the exemplary embodiments the variance of the cross-section of the microchannels can be non-linear. In some exemplary embodiments, at least two series of the mixing chambers 205 and microchannels 210 connect, however other embodiments can include a greater number of mixing chambers 205 and microchannels 210 in the series (e.g., three, four, five, etc.)

Referring to FIG. 2D, a first mixing chamber 205 is in series with two microchannels 210, in accordance with an exemplary embodiment of the disclosure. The mixing chamber can include a cavity through which the coating fluid moves downstream between the microchannels 210. The cavity can be subdivided into multiple portions, including an upper portion 206, a center portion 207 and a lower portion 208. In some embodiments the cavity can include more subdivisions, while in other embodiments the cavity may include less subdivisions. The upper portion 206 of the cavity can be proximate and in fluid communication to an upstream fluid inlet 211, which forms the bottom half of the upstream microchannel 210. The lower portion 208 of the cavity can be proximate and in fluid communication to a downstream fluid outlet 212, which forms the top half of the downstream microchannel 210. The cavity can have a variety of different shapes including ovular, hexagonal, etc. In FIG. 2D, an exemplary embodiment with a generally hexagonal cavity can be viewed, while in FIG. 2E an exemplary embodiment with a generally ovular cavity can be viewed. The cavity can have a cross-sectional area normal to the flow of the fluid through the cavity, which is represented by the arrows in FIGS. 2D and 2E. The cavity upper portion 206 can include the region in which the cross-sectional area of the cavity is increasing from a first point where the cavity upper portion 206 is proximate the fluid inlet 211. The cavity central portion 207 can include the region between where the cross-sectional area remains constant between the cavity upper portion 206 and the cavity lower portion 208. The cavity lower portion 208 can include the region in which the cross-sectional area of the cavity is decreasing until a point where the cavity lower portion 208 is proximate a downstream fluid outlet 212.

A purpose of shim(s) 250 is to create a slot gap between first and second plates, 201a, 201b, through which the fluids may flow. The geometry, including the series of an entry chamber 220, mixing chambers 205, microchannels 210, and an exit chamber 230 which can create variable internal mixing of the fluids flowing therein. In some exemplary embodiments, slot gap can lead from the channel 120 to an opening or outlet ends of the slot die. In some exemplary embodiments, cutouts in the shim(s) 250 define the geometry of the channel 120, and the shim(s) 250 can be interchanged to implement different internal mixing, flow behaviors, and patterning strategies. At least two fluid inlets 104a and 104b can be used to feed fluid to the channel 120. However, in some exemplary embodiments, multiple separate fluid inlets can be used (e.g., 3 inlets, 4 inlets, 5 inlets, 6 inlets, 7 inlets, 8 inlets, 9 inlets, 11 inlets, 13 inlets, 15 inlets, 17 inlets, 20 inlets).

In some exemplary embodiments, the entry chamber 220, mixing chambers 205, microchannels 210, an exit chamber 230, and the apparatus outlet can have variable widths. In a preferred embodiment the outlet can have a width of 1 cm and the microchannels can have a minimum width of 0.2 mm, which can induce more mixing.

Referring back to FIG. 1B, the shim configuration can be used for simultaneous deposition of two or more coating materials. As illustrated, a heterogeneous multi-material gradient pattern is produced when two fluids are fed into respective inlets (for example, corresponding both to respective height positions of two or more rows of inlets, and respective width positions of each inlet of the respective rows of inlets, alternating laterally along a width of the slot die) of the coating tool. While slot die coating has previously been adapted for deposition of narrow stripes of materials, internally mixing and depositing two or more coating fluids simultaneously into a gradient pattern is at least one novelty to this disclosure.

As shown in each of FIGS. 1A-B and 2A-B, the array of inlets 104a and 104b can include a first fluid inlet 104a that lies at a first height of the slot die across the width of the slot die, and a second (or second set of) fluid inlet(s) 104b that lies in a row at a second height of the slot die across the width of the slot die, wherein the first height is different than the second height, such that the length of each of the inlet channels of the first fluid inlet 104a is different than the length of second fluid inlet 104b.

The slot die body can be made of any machinable material typically used in making slot die. These include but are not limited to stainless steel, aluminum, titanium, nylon, polycarbonate and combinations thereof. The material used to make slot die body generally is a function of the fluid that will be deposited. There should be compatibility between the slot die and the fluid with respect to chemical, electrical, mechanical, and physical properties.

In another exemplary embodiment, the apparatus for patterning thin films can comprise the slot die, a first set of fluid inlets for feeding the first fluid material into the slot die, a second set of fluid inlets for feeding the second fluid material into the slot die, a first set of inlet channels laterally spaced apart and configured to receive the first fluid material, each of the inlet channels of the first set of inlet channels having a channel inlet coincident with a respective fluid inlet of the first set of fluid inlets in the slot die, a second set of inlet channels laterally spaced apart and configured to receive the second fluid material, each of the inlet channels of the second set of inlet channels having a channel inlet coincident with a respective fluid inlet of the second set of fluid inlets in the slot die, and a third interaction channel communicatively connected at an upstream end to the first and second sets of inlet channels, and at a downstream end to the fluid multi-material outlet in the slot die through which a pattern of alternating first fluid material and second fluid material can flow, wherein the first set of inlet channels and the second set of inlet channels are arranged in an alternating order, such that an inlet channel of the first set of inlet channels is followed by an inlet channel of the second set of inlet channels as viewed laterally across the slot die, wherein the third interaction channel is configured to receive at the upstream end alternating flows of the first fluid material and the second fluid material from the alternating layout of inlet channels, wherein the third interaction channel defines a volume extending in a flow direction from the upstream end to the downstream end and is further configured such that the third interaction channel is free of a physical barrier separating the flows of the first fluid material and the second fluid material, and wherein the cross-sectional area of the third interaction channel has a variable cross-sectional area from a width of the upstream end to a width of the downstream end, as the interaction channel transitions between chambers and microchannels.

The substrate can be moved at any suitable velocity to enable coating of the substrate. For example, according to exemplary embodiments of the present invention, a velocity of 10-50 mm per second is particularly preferred.

Any suitable film forming polymer can be used in the coating dispersion used in the process of this invention. Typical film forming polymers include, for example, but are not limited to, polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride-vinylchloride copolymers, vinylacetate-vinylidenechloride copolymers, styrenc-alkyd resins, polyvinylcarbazole, and the like.

In some exemplary embodiments, the coating dispersion used in the process can include, but are not limited to, polyvinyl alcohol (PVA), Mowiol® 4-88, poly(3,4-ethylenedioxythiophene):polystyrene sulfonate (PEDOT:PSS), Clevios PH1000, doped with 1% Triton X-100 surfactant and 6% ethylene glycol, polydimethylsiloxane (PDMS), Dow Corning 200® fluid, glycerol, and used in 95% concentration, and vacuum pump oil (VPO). In addition, slurries, polymers, and inks such as those used in the manufacture of solid-state batteries can be used in the process. Solid phase materials can also be included. Polyethylene terephthalate film (PET), ES301400, can be used as a flexible substrate for deposition of patterned films. PET shim stock can also be used to define the internal geometry of the hybrid slot coater, whose die block material is polymethyl methacrylate (PMMA), optically clear cast acrylic.

This disclosure also includes a method of preparing a gradient patterned thin film material. According to the method, a desired surface gradient pattern is first designed. The parameters of the designed surface pattern are input into a computer. A substrate having a substrate surface is passed under a hybrid patterning apparatus, and the designed surface gradient pattern is patterned onto the passing substrate surface using the hybrid patterning apparatus.

Substrates and fluids suitable for use in this disclosure can be any material one of ordinary skill would use in a thin film apparatus. Suitable substrates for use in accordance with this disclosure include, but are not limited to, paper, glass, thin plastic film, and thin metallic film. Plastic film is the preferred substrate. Suitable substrates can be flexible, rigid, uncoated, precoated, as desired. The substrates can comprise a single layer or be made up of multiple layers. Suitable fluids that may be deposited in the patterning of the substrate include, but are not limited to, dispersions and organic and inorganic polymer solutions.

### EXAMPLES

In accordance with this disclosure, a system has been designed and fabricated for the purpose of producing customized thin films. Initial studies have been performed to demonstrate such a system and to produce basic patterns as seen in various emergent technologies.

### Example 1: Materials and Methods

### Coating Fluids

In some exemplary embodiments, Polyvinyl alcohol (PVA), specifically Mowiol 4-88 can be used as a nonfunctional fluid phase. PVA can be prepared by dissolving a specified mass of PVA in deionized (DI) water, while stirring on a 60° C. hot plate with magnetic stirrer for 30 minutes. Concentrations of 7.5 wt. %, 10 wt. %, 15 wt. %, and 20 wt. % PVA solution can be made. To qualitatively analyze the gradient coating, yellow food coloring (FD&C Yellow 5) can be added to the center PVA fluid and blue food coloring (FD&C Blue 1 and Red 40) can be added to the side PVA fluid streams. A drop of food coloring can be added for every 2 mL of the PVA. The property details of various concentrations of PVA are given in Table 1.

In some exemplary embodiments, two functional materials can be used, poly(3,4-ethylenedioxythiophene) polystyrene sulfonate (PEDOT:PSS) and polyethylenimine (PEI). PEDOT:PSS can serve as an organic thermoelectric material. The properties of PEDOT:PSS are also given in Table 1. 25 wt. % PEI aqueous solution can be made by dissolving 50 g of 50 wt. % PEI into 50 g of DI water for 5 mins, at room temperature.

Gradient thin film can be formed using various combinations of the solutions such as 20 wt. %/10 wt. % PVA, PEDOT:PSS/7.5 wt. % PVA and 25 wt. % PEI/10 wt. % PVA, as shown in Table 1.

TABLE 1
Properties of PVA, PEDOT:PSS and PEI solutions, at
room temperature (20° C.) and pressure (1 atm).

| Fluid | Density (kg/m³) | Viscosity (mkg/m-s) |
|---|---|---|
| 7.5 wt. % PVA | 1015 | 15 |
| 10 wt. % PVA | 1020 | 40 |
| 15 wt. % PVA | 1030 | 200 |
| 20 wt. % PVA | 1045 | 800 |
| PEDOT:PSS | 1000 | 35 |
| 25 wt. % PEI | 1080 | 400 |

### Slot Die Coating

In some exemplary embodiments, the slot die coater can be made of polymethyl methacrylate (PMMA), conventionally known as acrylic glass, to allow for visual inspection of the internal flow. In an exemplary embodiment, 0.1 mm thick polyethylene terephthalate (PET), purchased from Goodfellow LTD can be used as the substrate and carrier web on the R2R manufacturing system.

A schematic of an example of the R2R, used to coat the gradient thin film, is shown in FIG. 1A. The slot die can be mounted such that two high-resolution cameras and microscopes could capture the internal flow and deposition of the coating fluid. The carrier web speed (V) and the flow rate of each fluid (center fluid Q_{CF} and side fluid Q_{SF}) can be controlled by a motorized roller and syringe pumps, respectively. The coating gap, H, can be set to create a small distance between the bottom of the slot die and the substrate. After coating, the gradient films were dried. Gradient thin film composed of PVA on the PET substrate can be placed in a 60° C. oven for 30 min. The PEDOT:PSS/PVA gradient thin film can be dried in a 60° C. oven for 1 hr.

The shim, a sheet placed between the two slot die halves along the perimeter to create desired offset distance G and the microchannel pattern that promotes mixing, can be made of 0.256 mm thick PET. The PET shim can be designed following techniques known in the art. As shown in FIG. 2A-C, the flow cavity consists of four microchannels with minimum width of 0.2 mm, to which can induce more mixing. The outlet width can be set as 1 cm to match the desired width of the gradient film. Three inlet ports can be cut into the shim to allow for each fluid stream (center fluid and two side fluid streams) to be introduced independently.

### Wetting and Surface Property Measurements

In some embodiments of the disclosure, wetting and surface properties of the PVA were analyzed to ensure good spreading of the coatings. The contact angle measurements were made to determine wettability using a Ramé-Hart Goniometer (Model 500-U1) in ambient conditions following the ASTM 7334-08 standard. The contact angles of the coating fluids were measured on the substrate, using Sessile drop method under ambient conditions.

### Characterization of Gradient Film

In some embodiments of the disclosure, the microstructure, geometry (width and thickness) and interfaces of the gradient thin film were analyzed using various microscopy techniques. A Phenom™ XL G2 scanned electron microscopy (SEM) was used to visually inspect the cross-section of the gradient thin film. A Nicolet™ iS™ 5 Fourier-transform infrared spectroscopy (FTIR) was used to analyze the chemical structure of the film, which can also be leveraged to verify the existence of a gradient structure. An Agilent® Cary 60 UV-Vis Spectrophotometer was used to analyze the gradient color scheme and the level of mixing.

Adhesion tests were performed on sample to understand the durability of the materials. While not quantitative, the peel tests conducted are standard. The adhesive strength of the gradient thin film was measured using cross-cut scratcher and Scotch® tape following the ASTM D3359 standard. This method provides a qualitative understanding of the adhesivity.

Electrical conductivity was measured using the four-point probe method. The probe contacts are in lines of polished copper with an overall width of 4.6 mm and each probe having width of 25.5 μm. The fabricated films were then cut to the 4.6 mm width and the measurements were made along the centerline, side, and gradient regions of the thin film.

### Example 2: Results and Discussion

### Properties of the Solutions

The contact angle and surface tension measurements of PVA, PEDOT:PSS and PEI on PET are provided in Table 2. DI water, which has a very poor wetting properties and causes dewetting, has contact angle of around 74° on the PET surface. From experimental experience, it was noticed that when contact angle between the fluid and solid is less than 60°, it is considered coatable. As shown in Table 2, the contact angle values of PVA are coatable but PEDOT:PSS and PEI do not meet the criteria. However, to coat these dewetting materials, different techniques are used. This will be further mentioned.

TABLE 2
Measured contact angle of different
fluids used on different surfaces.

| Fluid | On PET | Surface tension, σ |
|---|---|---|
| 7.5 wt. % PVA | 58° | 44 mN/m |
| 10 wt. % PVA | 56° | 44 mN/m |
| 15 wt. % PVA | 52° | 44 mN/m |
| 20 wt. % PVA | 52° | 44 mN/m |
| PEDOT:PSS | 74° | 70 mN/m |
| 25 wt. % PEI | 69° | 64 mN/m |

### Formation of Gradient Thin Films

Different combinations of PVA concentration were used fabricate gradient thin films via slot die coating. Based on the modified Peclet Number (Pe) formed in conventional studies, the flow rates through each inlet are calculated using Equation 1.

$$Pe = \frac{χ {Q}_{1} + {Q}_{2}}{2 {w}_{c} D} \qquad ( 1 )$$

In general form, Pe represents the ratio between the advective transport rate and the diffusive transport rate. In Equation 1, χ is the viscosity ratio between the center fluid and the side fluid where the center fluid has a higher viscosity, which promotes mixing. As known in the art, the fluid with the highest viscosity is maintained as the center fluid as less viscous side fluids act as the lubricant for the center fluid which decreases the overall viscous effect. Q₁ represents the mass flow rate at the center inlet, Q₂ represents the mass flow rate through each side channel, w_{c} is the width at the channel outlet and D represents the diffusion coefficient of the solute material. The range of Pe that would induce internal mixing of two miscible fluids within the planar geometry is between 5,000 and 15,000.

The w_{c} value for all experiments was set as 1 cm. The χ, Q₁ and Q₂ values for each combination material were altered to meet the Pe criteria as given in Table 3. Hence, a range of flow rates, Q₁ and Q₂, is needed for each fluid combination and the viscosity ratio, x, is set based on the materials of interest. Since χ is dependent upon the materials used, understanding the influence of χ is beyond the scope of this work. The values of the diffusion coefficients, D, for the PVA solutions range from 1.26×10⁻⁹ to 2.00×10⁻⁹ depending on their concentration. The diffusion coefficient, D, for PEDOT:PSS is 1.5×10⁻¹² m²/s¹ and for 20 wt. % PEI, it is 2×10⁻¹⁰ m²/s.

TABLE 3
Flow rate calculation following Equation 1
for each combination of PVA concentration.

| | Index | | | | |
|---|---|---|---|---|---|
| Sample | | | | Q₁ | Q₂ |
| # | Center Fluid | Side Fluid | χ | (ml/min) | (ml/min) |
| S1 | 20 wt. % PVA | 10 wt. % PVA | 20 | 0.6~1.5 | 0.3~1.0 |
| S2 | PEDOT:PSS | 7.5 wt. % PVA | 2.33 | 0.9~1.1 | 1.1~1.3 |
| S3 | 25 wt. % PEI | 10 wt. % PVA | 10 | 0.8~1.0 | 0.6~1.0 |

### Effect of Flow Rate

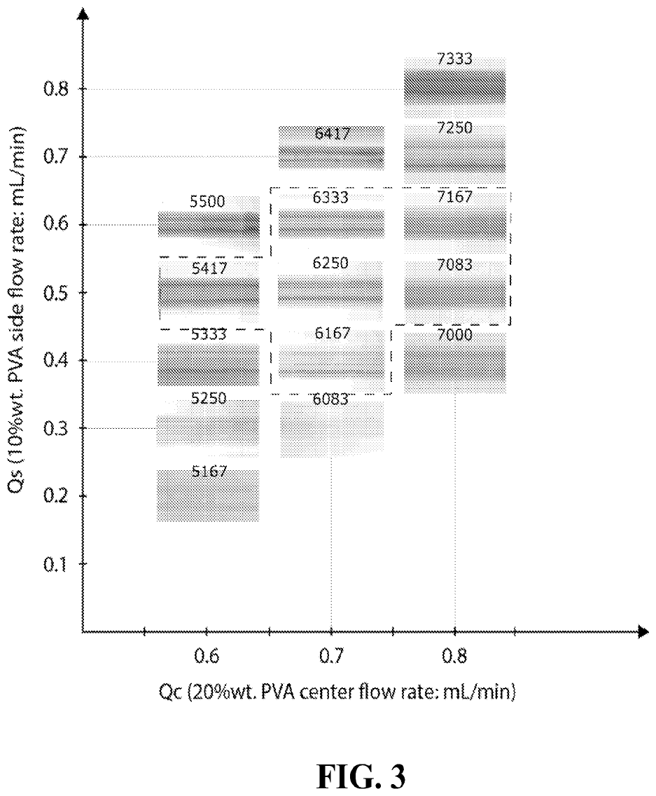

The effect of flow rate on the quality of the gradient thin film, as illustrated in FIG. 3. Here, 20 wt. % yellow PVA (center flow stream) and 10 wt. % blue PVA (side flow streams) were used. To understand the effect of changing the flow rate, either the flow rate of the center flow stream or the side flow streams were held constant while the other was changed in increments of 0.1 ml/min. As shown in FIG. 3, gradient structures were formed, while the flow rate impacts the geometry and integrity of the coated film. For Pe value between 5,000-15,000, the center flow rate ranges from 0.6 to 0.8 mL/min while the side flow rate ranges from 0.3 to 0.5 mL/min, as shown by the solid lined box in FIG. 3. When the Pe value is lower than 5,000 (e.g., Q₁=0.6 mL/min and Q₂=0.6 mL/min) irregular coating occurs, whereas when Pe is greater than 15,000 (e.g., Q₁=0.8 mL/min and Q₂=0.4 mL/min) the center flow dominates the overall film. It is known that the if the flow is below the lower Pe limit of 5,000, the center flow becomes very non-uniform with wavy patterns noted in the center flow because during the diffusion process, x locally decreases and overall stream width narrows which causes distorted wave-like flows. When Pe is over the upper limit of 15,000, the center flow starts to dominate the overall flow since the change in center flow rate has biggest impact on the Pe and this results in two fluids stacking.

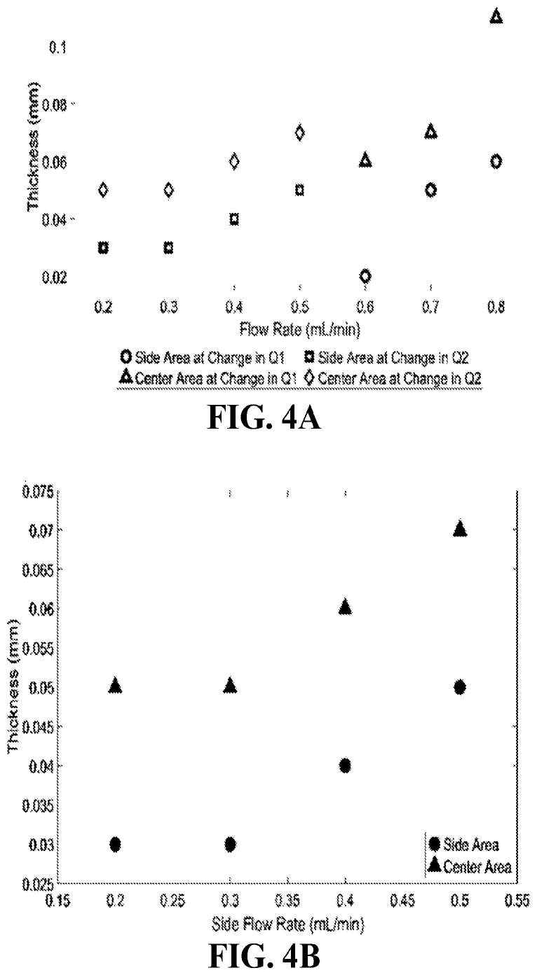

The width and thickness of each coated area are compared in FIGS. 4A-B. It was noticed that the alteration in center flow rate had more impact on the mixing mechanism with wider area of gradient areas and center area as shown in FIG. 4A. The change in the side flow rate had an impact on mixing and overall geometry of the gradient structure but compared to the change in center flow rate, the impact is marginal as shown in FIG. 4B. This phenomenon happens because viscosity only affects the center flow rate, based on Equation 1. Hence, as viscosity ratio between the two fluids are larger, it is likely that there are more diffusion as more viscous fluids have higher tendency of molecular movement.

### Functionally Graded Thin Film

Functionally graded thin film were formed using the R2R method discussed to illustrate that the gradients formed on the film can exhibit multifunctionality (e.g., active and/or in active areas. In a recent study, it was shown that two miscible materials can be co-deposited simultaneously, even if one fluid is a wetting and the other is non-wetting. A non-wetting fluid generally poses significant challenges and fluid chemistry or surface modifications. However, that work showed that the wetting fluid can stabilize or scaffold the non-wetting fluid allowing both materials to be co-deposited on a R2R without the need for these modifications. Following this discovery, gradients of a functional material, e.g., non-wetting PEDOT:PSS stabilized with PVA were fabricated and analyzed. The functional materials, e.g., conductive polymers, served as the center fluids for the samples. It should be noted that typically PEDOT:PSS is altered with surfactants or other additives prior to coating to enhance its wettability. However, gradient thin films are achievable without the need for such alterations. It is believed that the wetting fluid, i.e., PVA, acts as a wetting enhancer or scaffold, though slow it is believed that mixing, due to diffusion, is aiding the film coating stability.

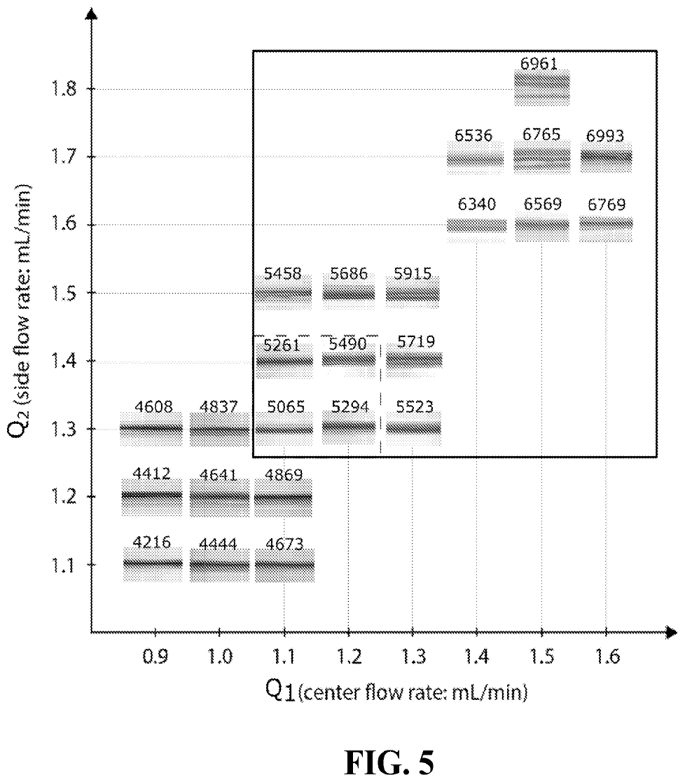

A parametric study was performed, such that the flow rates exceed both the lower and upper limits of the Pe values where mixing is induced. This study allows for comparing the theoretical and experimental values. Although the flow rate ranges are deduced to have nine different possible working conditions, as shown in the solid line box area of FIG. 5, only four combinations had quality gradient formation where clear color scheme is noticeable, as shown in the dashed box of FIG. 5. Conversely, at flow rate combinations below the lower Pe limit, the center flow shows eroded wavy patterns and beyond the upper Pe limit, the center flow dominates the film structure.

For the diffusion to occur, the center flow needs to have a higher viscosity compared to the side viscosity. Unfortunately, PVA solutions with higher than 7.5 wt. % had higher viscosity than PEDOT:PSS and less viscous PVA resulted in coating defect, i.e., dripping. Therefore, the change in viscosity ratio was not so feasible as the PEDOT:PSS used is difficult to increase the viscosity. Although, some combinations of Pe are still within the calculated range, the gradient does not seem to be formed when the center flow dominates. Moreover, the area that PEDOT:PSS covers are very narrow compared to that of 20 wt. % PVA/10 wt. % PVA gradient films, regardless of concentration. Such phenomenon occurs due to the significantly low D value of PEDOT:PSS. Therefore, it is likely that the 20 wt. % PVA/10 wt. % PVA concentrations are inter-diffusing into each other as the diffusion coefficient of PVA is high compared to that of PEDOT:PSS. Whereas, for the PEDOT:PSS/7.5 wt. % PVA gradient thin film, the 7.5 wt. % PVA diffuses into PEDOT:PSS.

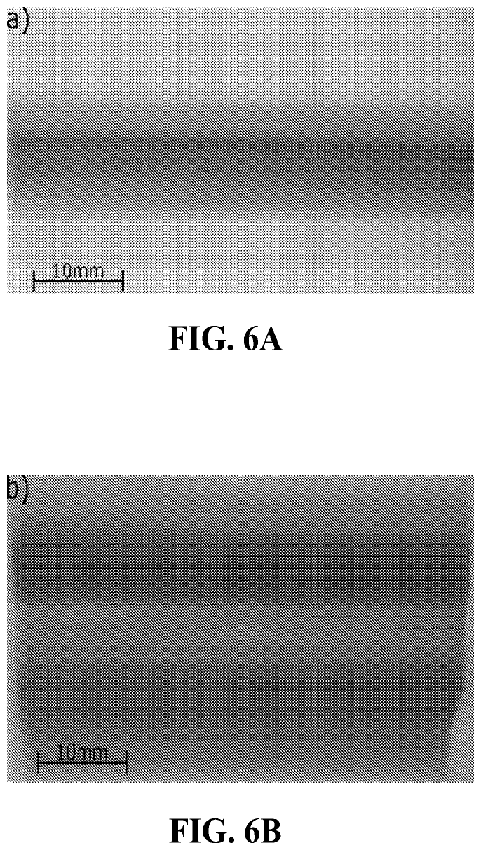

Comparing PEDOT:PSS/7.5 wt % yellow PVA, FIG. 6A, coated at flow rates of 1.1 mL/min and 1.4 mL/min respectively to 25 wt. % PEI/10 wt. % red PVA, FIG. 6B, coated at flow rates of 1.0 mL/min and 0.8 mL/min, respectively, it is observed that the mixing is more prominent for the 25 wt. % PEI/10 wt. % red PVA, as shown in FIG. 6A-B. It is evident that the red food dye of FIG. 6B gets significantly mixed into the clear PEI, resulting in a much higher gradient region. While the same may be true for the PEDOT:PSS of FIG. 6A, which would validate the wetting enhancement that is observed, characterizing the composition of the material is very difficult for such a small amount of PVA in the specific region of interest.

### Effect of Mixing/Diffusion

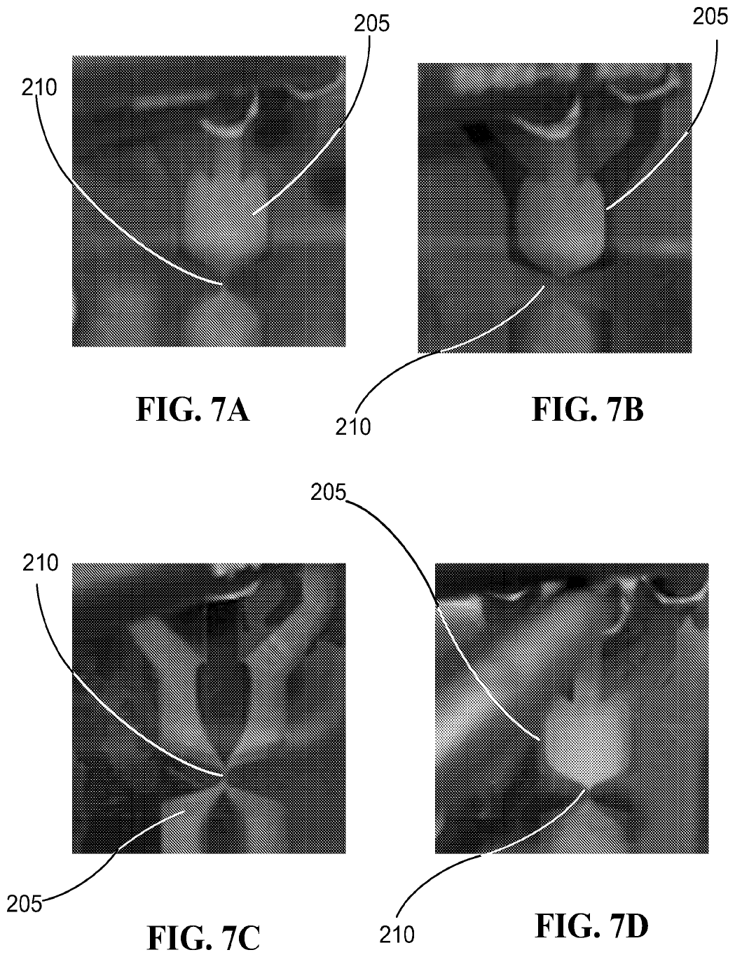

It is observed that while the functional materials can be fabricated, the level of diffusion or mixing between the fluids changes significantly as a function of x. As shown in FIGS. 7A-D, as the value of x increases, the diffusion of the fluids after passing through the first microchannel is larger. Unfortunately, the quality of mixing could only be shown macroscopically. The diffusion of the two fluids were greater in FIGS. 7B and 7D which have x value of 20 and 10, respectively. The diffusion is less for smaller x value as shown in FIGS. 7A and 7C which were 5 and 2.667 respectively. The differences in the colors after the fluids pass through the microchannel at large and small x are clear.

### SEM Imaging

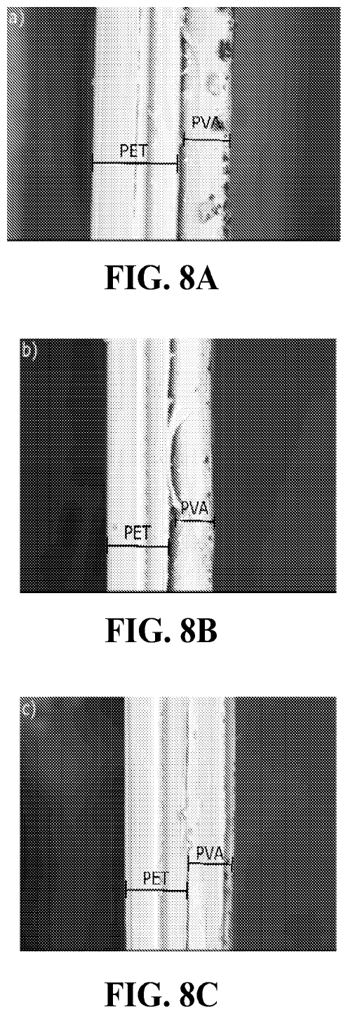

The cross-sectional images shown in FIGS. 8A-C better depict the thickness difference along the gradient structure. For 20 wt. %/10 wt. % PVA gradient film, the thickness of center, side and gradient area are 68.70 μm, 51.32 μm and 55.72 μm respectively as shown in FIGS. 8A-C.

### UV-Vis Spectrometry

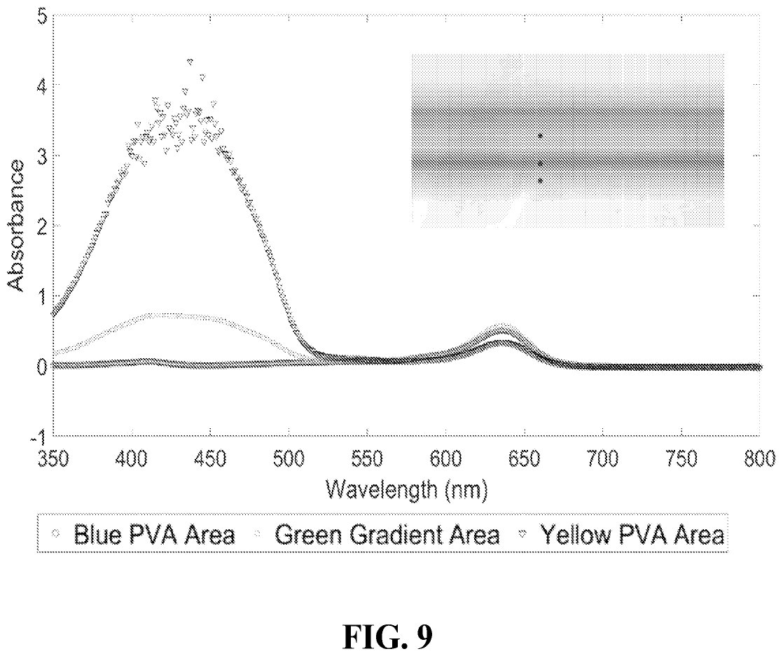

UV-vis spectrometer was used to assess the gradient structure based on the absorbance peaks of each pigment, as shown in FIG. 9. As an example, a 20 wt. %/PVA 10 wt. % PVA gradient thin film where Q₁=0.7 mL/min and Q₂=0.5 mL/min was analyzed. The characterized sample is shown as an inset in FIG. 9, where the 20 wt. % yellow PVA is shown along the center, 10 wt. % blue PVA is shown along the sides and green which shows the gradient region, i.e., concentrations of 20 wt. %/10 wt. % PVA. The peak absorbance for the blue pigment is at a wavelength of approximately 630 nm and approximately 405 nm for the yellow pigment. As shown in FIG. 9, the absorbance peaks for the blue and yellow follow the known wavelength values and in the gradient area both peaks are apparent, thus both pigments co-exist in this region. It can be observed that a small amount of blue pigment diffuses into the center fluid. This is expected, because at higher Pe values the side fluid begins to mix with the center fluid. It should be noted that the scattering illustrated in the yellow absorbance peak is due to experimental error.

### Adhesion Test

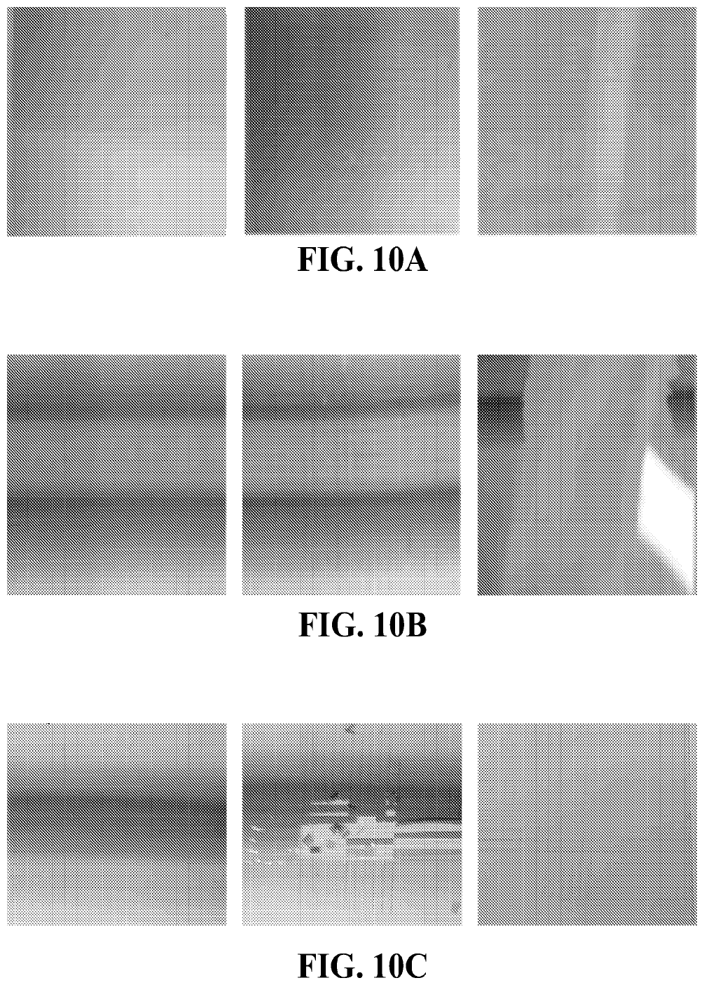

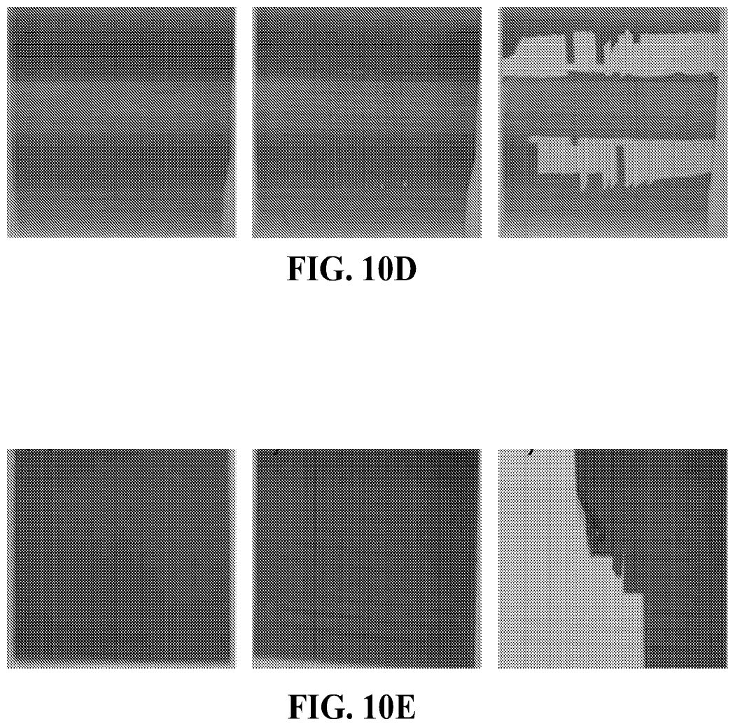

To understand the adhesion of the various samples, four samples were tested including 10 wt. % PVA, 20 wt. % PVA/10 wt. % PVA gradient thin film, PEDOT:PSS/7.5 wt. % PVA gradient film, 25 wt % PEI/10 wt. % PVA gradient film and 25 wt % PEI/10 wt. % PVA fully blended, as illustrated in FIGS. 10A-E. For each set of data, the unscratched (as fabricated) samples are shown in the first column, the scratched samples are shown in the second column, and the tested samples (scotch tape pull test) are show in the third column.

10 wt. % PVA serves as a control, although other concentrations of PVA were used in the study. It is believed that 10 wt. % PVA is representative of the behavior that would be exhibited by the other PVA concentrations. It was observed that 10 wt. % PVA has very poor adhesion on PET, as illustrated in FIGS. 10A-E. 10 wt. % PVA on PET exhibits category 0B delamination, meaning complete or near complete removal of the PVA from the PET surface, as exhibited in FIG. 10A.

A 10 wt. %/20 wt % PVA gradient thin film was made and assessed, as shown in FIG. 10B. It has been further observed that regardless of PVA concentration, e.g., 10 wt. %-20 wt % since the gradient region would be some concentration between 10 and 20 wt % PVA, the adhesive forces of the PVA on PET are not improved, as demonstrated in FIG. 10B. Hence, in the case of PVA/PVA gradient thin films, the structure had no improvement or added advantage when fabricated as a gradient structure. Theoretically this is expected since no other modifications were made to the PET surface. Others have shown that altering the surface chemistry by corona treatment or other methods, will improve the adhesion characteristics, however, in this work the arm was to avoid any surface or chemical modifications.

PEDOT:PSS/7.5 wt. % PVA gradient film was tested, as shown in FIG. 10C. It is observed that the PEDOT:PSS started delaminating during the scratching stage, as shown in FIG. 10C. The overall assessment is an evaluation of 0B, complete delamination of the PEDOT:PSS/7.5 wt. % PVA gradient structure, as shown in FIG. 10C. One of the main reasons PEDOT:PSS/7.5 wt. % PVA delaminates from the PET surface is because PVA is non-ionic and PEDOT:PSS is negatively charged when PET is negatively charged.

A gradient thin film of 25 wt. % PEI and 10 wt. % PVA was tested, as shown in FIG. 10D. Interestingly, this gradient structure has mixed delamination results. As illustrated in FIG. 10D, the 25 wt. % PEI is category 5B (0% delamination) and only the PVA delaminated, receiving a category 0B (100% delamination) assessment. Furthermore, the mixed region exhibited very high adhesion to the PET surface also obtaining a category 5B assessment even with the presence of PVA. It is well known that positively charged beads have higher adhesive forces on negatively charged surfaces. Since PEI is positively charged and PET film is negatively charged, the high adhesion force of the 25 wt. % PEI on PET is expected due to ionic bond adhesion.

25 wt. % PEI and 10 wt. % PVA solution were fully blended in 1:1 weight ratio to also prove the efficiency of the gradient structure, as shown in FIG. 10E. It is observed that approximately 50% of the blend film delaminated, thus receiving category 1B (35%˜ 65% delamination). The gradient structure, although considered mixing of two fluids, exhibited better adhesion properties which infers that gradient structure improves the overall adhesion.

### Conductivity Test

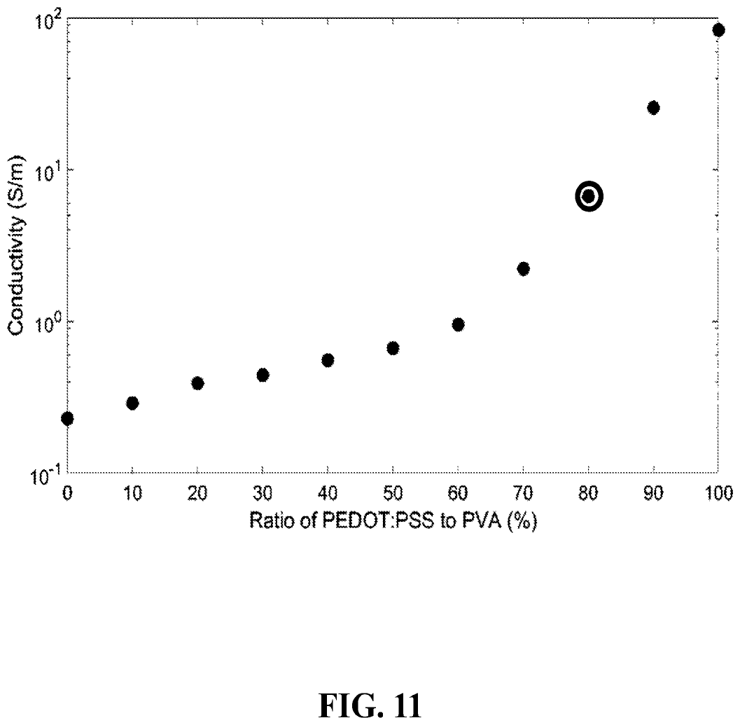

Droplets of varying ratios of blade coated PEDOT:PSS/7.5 wt. % PVA mixtures were tested to determine the electrical conductivity for graded blends of PEDOT:PSS/7.5 wt. % PVA, as shown in FIG. 11. This data can be used to verify the existence of a gradient film as well as aid with quantitative assessment the overall material concentrations within the measured regions. The measured electrical conductivity of these materials is provided in FIG. 9. The thickness of each drop was measured using a micrometer. The coatings had a uniform thickness of roughly 0.03 mm+0.002 mm regardless the weight ratio, however, the widths were not uniform. Based on literature, the conductivity of PEDOT:PSS ranges from 20 to 100 S/m and PVA film has conductivity of 0.248 S/m. As shown in FIG. 9, the conductivity of droplets of pure 7.5 wt. % PVA, PEDOT:PSS/7.5 wt. % PVA blends, and PEDOT:PSS as purchased, ranged from 0.22 S/m to 83.3 S/m. Such increase in electrical conductivity is also observed in previous works where PVA/PEDOT:PSS blends were analyzed. In this case, the conductivity at the gradient structure is the same as the 80% PEDOT:PSS/7.5 wt. % PVA solution with 6.67 S/m, shown in FIG. 11. These results of the conductivity are a significant improvement on those reported in conventional studies, for electrospun fully blended mixture of PEDOT:PSS and PVA solutions. The conventional studies exhibited significantly lower conductivity, ranging from 0.00048 to 0.0017 S/m for thin film which were about 250 nm thick. Even so, the gradient structure produces higher electrical conductivity compared to that of the fully blended materials. Hence, it is anticipated qualitative analysis of the functionally graded thin film can be assessed based on electrical conductivity, e.g., does a region have more or less PEDOT:PSS or 7.5 wt. % PVA.

### Fourier Transform Infrared (FTIR) Spectroscopy

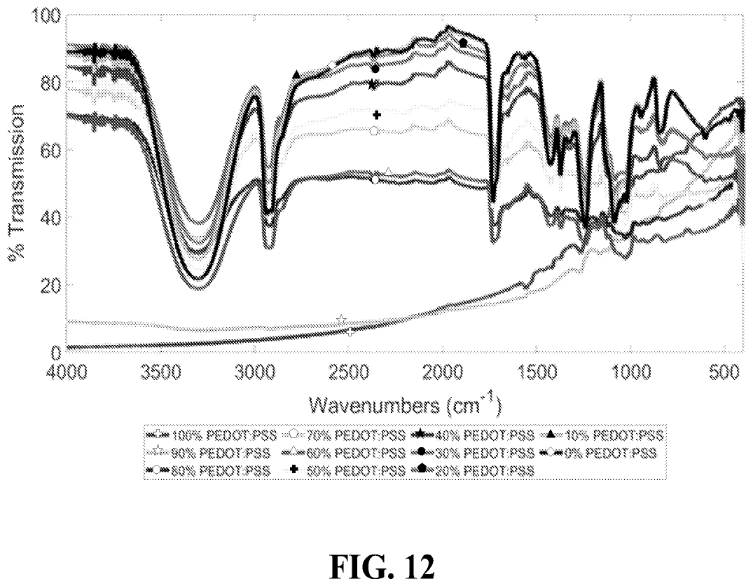

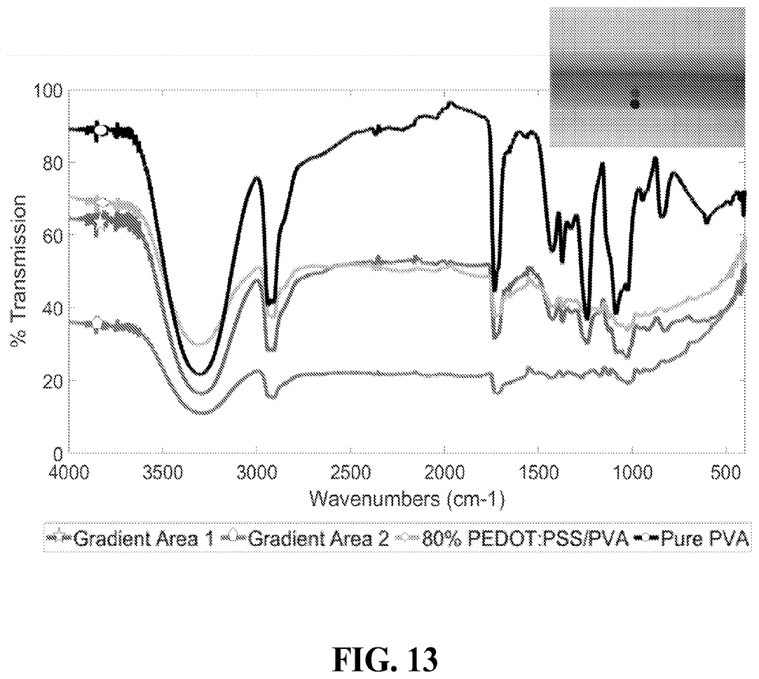

As shown in FIG. 12, the PEDOT:PSS/10 wt. % PVA blends follow the FTIR curves of PVA, when the ratio of PEDOT:PSS to PVA is at or below 80% ratio. As the ratio increases above 80%, the FTIR peak patterns start to follow those of PEDOT:PSS. This is also comparable to the FTIR results from the gradient structure, where even at the PEDOT:PSS area, some of the peaks shown in PVA results are present. In FIG. 13, the Gradient Arca 1 represents gradient area closer to 10 wt. % PVA and Gradient 2 represents the gradient area closer to PEDOT:PSS. The FTIR results show that the peaks start to decrease as the PVA contents decrease. Also, it can be seen that the 80% PEDOT:PSS/PVA has similar FTIR graph as the gradient area closer to PEDOT:PSS boundary, as shown in FIG. 13. This explains why the gradient structure shows the same electrical conductivity value as the 80% PEDOT:PSS/PVA which also shows the electrical efficiency of the gradient structure as such structure assumes 50% mix of the two materials.

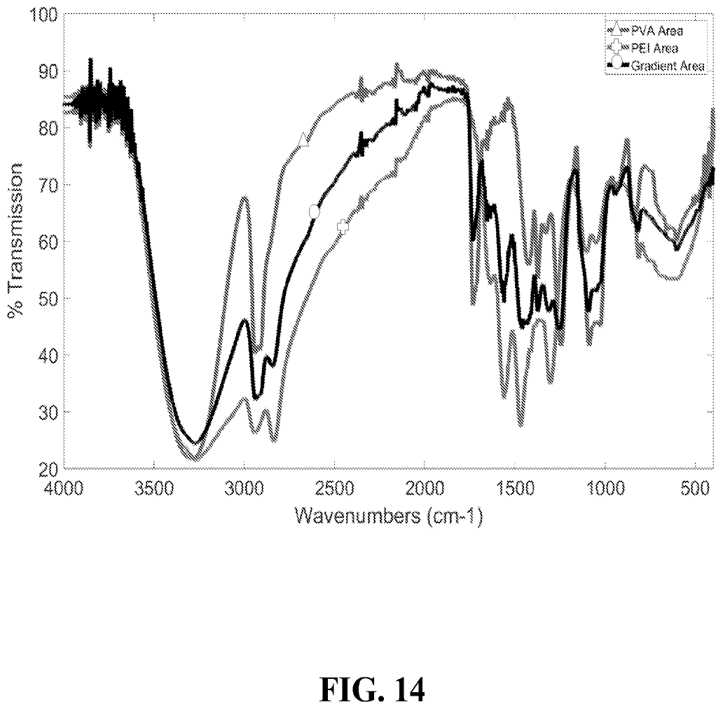

The FTIR result of PEI/PVA gradient thin film is as shown in FIG. 14. It is observed that the % transmission peaks of the gradient structures lay between the PVA and PEI peaks. Also, the material library embedded in the FTIR tool compares the peaks with the database where the red PVA area had 74.64% correlation with the library data, the gradient area had 59% correlation and PEI, like PEDOT:PSS, has no correlations in the FTIR library. This shows that as the PVA content comparing with the data from the literature, the peaks looked very identical with very minor differences.

### Example 3: Conclusion

The gradient can be formed instantly and be coated using slot die coating method mounted on R2R system. Using the correct coating parameters, the mixing in the internal area and at deposition is noticed to a desired dimension. Results shown in SEM and FTIR clearly defends the existence of gradient structure. The gradient formation deemed to have improve the materials' mechanical and electrical properties compared to completely mixed materials in previous work. Although the mechanical properties were not improved due to the material's poor nature, the electrical conductivity has greatly improved compared to that of fully mixed materials. It is noted that the gradient structure has same efficiency as 80% PEDOT:PSS/PVA mixture. Using the PEI, the adhesive property of the gradient structure is verified where PEIPVA gradient regions showed greatly improved adhesive properties compared to plain PVA coating and fully blended PEI/PVA coating on PET. The scalable manufacturing method can be used to instantaneously fabricate gradient patterned thin films for many different materials. Moreover, functional materials can be further used to have improved functionality in many other areas.

1. An apparatus comprising:
fluid inlets;
a slot die outlet; and
fluidically connected chambers;
wherein:
the fluidically connected chambers are arranged to define a flow path for fluids flowing in a fluid direction from the fluid inlets to the slot die outlet;
the geometries of the flow path are configured to generate a heterogeneous film comprising a scalable gradient pattern of mixed fluids;
the slot die outlet is configured to deposit the heterogeneous film onto substrate; and
each chamber is selected from a group consisting of an entry chamber, a mixing chamber, and an exit chamber.

2. The apparatus of claim 1, wherein:
each mixing chamber comprises:
a mixing chamber inlet having a first end and a second end;
a mixing chamber outlet having a first end and a second end; and
a mixing chamber cavity between the mixing chamber inlet and the mixing chamber outlet, the mixing chamber cavity having:
an upper portion having a first end proximate the second end of the mixing chamber inlet and a second end;
a central portion having a first end proximate the second end of the upper portion and a second end;
a lower portion having a first end proximate the second end of the central portion and a second end proximate the first end of the mixing chamber outlet; and
a variable cross-sectional area normal to the flow direction through the mixing chamber;
the entry chamber comprises:
an entry chamber cavity between the fluid inlets and an entry chamber outlet having a first end and a second end;
the entry chamber cavity having:
an upper portion having a first end proximate the fluid inlets and a second end;
a lower portion having a first end proximate the second end of the upper portion and a second end proximate the first end of the entry chamber outlet; and
a variable cross-sectional area normal to the flow direction through the entry chamber; and
the exit chamber comprises:
an exit chamber inlet having a first end and a second end; and
an exit chamber cavity between the send end of the exit chamber inlet and the slot die outlet;
the exit chamber cavity having:
an upper portion having a first end proximate the second end of the exit chamber inlet and a second end;
a lower portion having a first end proximate the second end of the upper portion and a second end proximate the slot die outlet; and
a variable cross-sectional area normal to the flow direction through the exit chamber.

3. The apparatus of claim 2, wherein:
the fluidically connected chambers comprise two of the mixing chambers, a first mixing chamber and a last mixing chamber;
the first and last mixing chambers arranged serially in the flow direction; and
each mixing chamber cavity has a shape selected from a group consisting of a generally ovular shape and a generally hexagonal shape.

4. The apparatus of claim 3, wherein;
the fluidically connected chambers further comprise at least one of:
the entry chamber; or
the exit chamber;
the chambers arranged serially in the flow direction; and
the cavity of the entry chamber and the cavity of the exit chamber has, individually, a shape selected from a group consisting of a generally semi-circular shape and a generally pentagonal shape.

5. (canceled)

6. The apparatus of claim 2, wherein:
the fluidically connected chambers comprise:
the entry chamber;
at least two of the mixing chambers; and
the exit chamber;
the chambers are arranged serially from the entry chamber, to the mixing chambers, to the exit chamber, in the flow direction;
each of the upper portions of the mixing chamber cavities has a cross-sectional area normal to the flow direction that increases from the first end of the upper portion to the second end of the upper portion; and
the upper portion of the exit chamber cavity has a cross-sectional area normal to the flow direction that increases from the first end of the upper portion to the second end of the upper portion.

7. The apparatus of claim 6, wherein each of the increasing cross-sectional areas normal to the flow direction is selected from a group consisting of increasing linearly and increasing non-linearly.

8. (canceled)

9. The apparatus of claim 2, wherein:
the fluidically connected chambers comprise:
the entry chamber;
at least two of the mixing chambers; and
the exit chamber;
the chambers are arranged serially from the entry chamber, to the mixing chambers, to the exit chamber, in the flow direction;
each of the lower portions of the mixing chamber cavities has a cross-sectional area normal to the flow direction that decreases from the first end of the lower portion to the second end of the lower portion; and
the lower portion of the entry chamber cavity has a cross-sectional area normal to the flow direction that decreases from the first end of the lower portion to the second end of the lower portion.

10. The apparatus of claim 9, wherein each of the decreasing cross-sectional areas normal to the flow direction is selected from a group consisting of decreasing linearly and decreasing non-linearly.

11. (canceled)

12. The apparatus of claim 2, wherein:
the fluidically connected chambers comprise:
the entry chamber;
at least two of the mixing chambers; and
the exit chamber;
the chambers are arranged serially from the entry chamber, to the mixing chambers, to the exit chamber, in the flow direction;
each of the upper portions of the mixing chamber cavities has a cross-sectional area normal to the flow direction that increases from the first end of the upper portion to the second end of the upper portion;
each of the central portions of the mixing chamber cavities has a cross-sectional area normal to the flow direction that is constant from the first end of the central portion to the second end of the central portion;
each of the lower portions of the mixing chamber cavities has a cross-sectional area normal to the flow direction that decreases from the first end of the lower portion to the second end of the lower portion;
the lower portion of the entry chamber cavity has a cross-sectional area normal to the flow direction that decreases from the first end of the lower portion to the second end of the lower portion;
the upper portion of the exit chamber cavity has a cross-sectional area normal to the flow direction that increases from the first end of the upper portion to the second end of the upper portion;
each of the increasing cross-sectional areas normal to the flow direction is selected from a group consisting of increasing linearly and increasing non-linearly; and
each of the decreasing cross-sectional areas normal to the flow direction is selected from a group consisting of decreasing linearly and decreasing non-linearly.

13. The apparatus of claim 2, wherein:
each mixing chamber inlet has a cross-sectional area normal to the flow direction that increases from the first end of the mixing chamber inlet to the second end of the mixing chamber inlet; and
each mixing chamber outlet has a cross-sectional area normal to the flow direction that decreases from the first end of the mixing chamber outlet to the second end of the mixing chamber outlet.

14. The apparatus of claim 13, wherein each of the increasing cross-sectional areas of the mixing chamber inlets normal to the flow direction increase non-linearly; and
each of the decreasing cross-sectional areas of the mixing chamber outlets normal to the flow direction decrease non-linearly.

15.-20. (canceled)

21. A system comprising:
the apparatus of claim 12;
a first fluid; and
a second fluid;
wherein:
a first fluid inlet of the fluid inlets is configured to feed the first fluid to the entry chamber; and
a second fluid inlet of the fluid inlets is configured to feed the second fluid to the entry chamber.

22. The system of claim 21 further comprising:
a third fluid inlet of the fluid inlets configured to feed one of the first fluid or the second fluid to the entry chamber.

23. The system of claim 21 further comprising:
a third fluid;
wherein one of the first fluid inlet, the second fluid inlet, or a third fluid inlet of the fluid inlets is configured to feed the third fluid to the entry chamber.

24.-45. (canceled)

46. The apparatus of claim 1, wherein the fluid inlets, the chambers, and the slot die outlet are configured to enable fluidic communication through the apparatus in a continuous flow.

47. The apparatus of claim 3, wherein the fluidically connected chambers further comprises one or more additional mixing chambers positioned between the first mixing chamber and the last mixing chamber.

48. The system of claim 21, wherein each of the mixing chambers further comprises characteristics optimizable based on the two fluids.

49. The system of claim 21, wherein each of the mixing chambers is configured to enable a turbulent flow of the two fluids through the apparatus.

50. The apparatus of claim 1, wherein the apparatus comprises a material selected from a group consisting of stainless steel, aluminum, nylon, polycarbonate and combinations thereof.

51. The system of claim 21, wherein the apparatus is configured to generate a scaled gradient pattern from mixing the two fluids within mixing chambers.

52. A method of thin film material deposition on a substrate comprising:
feeding at least two fluids into a slot die via a plurality of fluid inlets;
forming a fluid multi-material by interacting the at least two fluids in a plurality of mixing chambers within the slot die, the plurality of mixing chambers in fluidic communication with the plurality of fluid inlets such that the at least two fluids mix within the plurality of mixing chambers; and
depositing the fluid multi-material onto the substrate via an outlet of the slot die in fluidic communication with the plurality of mixing chambers.

53. The method of claim 52, wherein at least one of:
feeding the at least two fluids are at a plurality of fluid flow rates;
the at least two fluids comprise a first fluid and a second fluid, and feeding the first fluid into the slot die is at a first fluid rate and feeding the second fluid into the slot die is at a second fluid rate;
the plurality of fluid inlets comprises a first fluid inlet and a second fluid inlet, the first fluid fed into the first fluid inlet and the second fluid fed into the second fluid inlet;
the plurality of fluid inlets comprises a first fluid inlet, a second fluid inlet, and a third fluid inlet, the first fluid fed into the first fluid inlet and the second fluid fed into the second fluid inlet and the third fluid inlet;
controlling the plurality of fluid flow rates adjusts a mixture ratio of the at least two fluids;
controlling dimensions of the plurality of mixing chambers adjusts a mixture ratio of the at least two fluids;
the slot die comprises a first plate, a second plate, a shim separating the first plate and the second plate;
the shim separating the first plate and the second plate forms the plurality of mixing chambers;
the substrate is selected from a group consisting of paper, glass, thin plastic film, and thin metallic film; or
the method further comprises dimensionally scaling at least a portion of the fluid multi-material.

54.-61. (canceled)
